(19) United States
(12) Patent Application Publication
(10) Pub. No.: US 2013/0159345 A1
(43) Pub. Date: Jun. 20, 2013

(54) METHODS AND APPARATUSES FOR FACILITATING DETERMINATION OF AVAILABLE SPECTRUM

(71) Applicants: Jussi Tapani Kahtava, Fleet (GB); Kodo Shu, Kawasaki City (JP)

(72) Inventors: Jussi Tapani Kahtava, Fleet (GB); Kodo Shu, Kawasaki City (JP)

(73) Assignee: NOKIA CORPORATION, Espoo (FI)

(21) Appl. No.: 13/818,603

(22) PCT Filed: Aug. 24, 2010
(86) PCT No.: PCT/IB2010/053808

§ 371 Date: Feb. 22, 2013

(51) Int. Cl. G06F 17/30

(52) U.S. Cl. CPC G06F 17/30424
USPC 707/770

(57) ABSTRACT

Methods and apparatuses are provided for facilitating determination of available spectrum. A method may include receiving a query originated by a white space device for an indication of available frequency spectrum at a location of the white space device. The method may further include determining whether the location of the white space device is within an area served by a first database. In an instance in which it is determined that the location of the white space device is not within the area served by the first database, the method may additionally include determining a second database and causing access information for the second database to be provided to the white space device. The determined second database may serve an area including the location of the white space device. Corresponding apparatuses are also provided.

### TECHNOLOGICAL FIELD

Example embodiments of the present invention relate generally to communications technology and, more particularly, relate to methods and apparatuses for facilitating determination of available spectrum.

### BACKGROUND

The modern communications era has brought about a tremendous expansion of wireline and wireless networks. Wireless and mobile networking technologies have addressed related consumer demands, while providing more flexibility and immediacy of information transfer. Concurrent with the expansion of networking technologies, an expansion in computing power has resulted in development of affordable computing devices capable of taking advantage of services made possible by modern networking technologies. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor have become ubiquitous and are used to access network applications and services by consumers of all socioeconomic backgrounds.

The increased use of mobile computing devices and the growth in capability thereof has resulted in a need for additional frequency spectrum to carry data in mobile communications. Conveniently, the evolution from analog broadcast television to digital broadcast television has freed up portions of the electromagnetic spectrum in many areas. As such, in the United States, the Federal Communications Commission (FCC) issued a 2009 ruling allowing devices that satisfy certain conditions/requirements to be able to access television bands, which are unused at a specific place and at a specific time. This unused portion of the television spectrum is often referred to as white space (WS), and devices configured to make use of white space are referred to as white space devices (WSDs). Other national regulatory agencies tasked with regulating the frequency spectrum in various jurisdictions, such as the European Conference of Postal and Telecommunications Administrations (CEPT), are following the FCC's lead and are likewise promulgating standards regulating usage of WS by WSDs under specified conditions.

### BRIEF SUMMARY

Methods, apparatuses, and computer program products are herein provided for facilitating determination of available spectrum. Systems, methods, apparatuses, and computer program products in accordance with various embodiments may provide several advantages to white space devices, users of white space devices, and national regulatory authorities tasked with regulating frequency spectrum usage. Some example embodiments advantageously enable white space device roaming between areas served by different white space databases. In this regard, some example embodiments provide a white space device configured to contact a default white space database, which may be configured to determine whether the white space device is located outside of an area served by the database and, if so, provide the white space device with access information for a white space database serving an area in which the white space device is located. As such, the burden of determining an appropriate white space database when a white space device is roaming to another country may be removed from the white space device and/or a user of the white space device.

Further, some example embodiments provide for coordination between white space databases serving bordering areas. In this regard, such example embodiments enable a white space device in a border region to query a database serving a border region area in which the white space device is located. The contacted database may coordinate with a database serving an area across the border so as to determine available frequency spectrum in the border region that may not interfere with incumbent traffic on the other side of the border. Accordingly, such embodiments may eliminate the need for black out zones in border regions wherein a transmission interference zone of a white space device may extend across the border.

In a first example embodiment, a method is provided, which comprises receiving, at a database apparatus configured to provide access to a first database, a query originated by a white space device for an indication of available frequency spectrum at a location of the white space device. The method of this example embodiment further comprises determining whether the location of the white space device is within an area served by the first database. In an instance in which it is determined that the location of the white space device is within the area served by the first database, the method of this example embodiment also comprises causing an indication of available frequency spectrum at the location of the white space device to be provided to the white space device. In an instance in which it is determined that the location of the white space device is not within the area served by the first database, the method of this example embodiment additionally comprises determining a second database serving an area including the location of the white space device and causing access information for the second database to be provided to the white space device.

In another example embodiment, an apparatus comprising at least one processor and at least one memory storing computer program code is provided. The at least one memory and stored computer program code are configured, with the at least one processor, to cause the apparatus of this example embodiment to at least receive a query originated by a white space device for an indication of available frequency spectrum at a location of the white space device. The at least one memory and stored computer program code are configured, with the at least one processor, to further cause the apparatus of this example embodiment to determine whether the location of the white space device is within an area served by a first database. In an instance in which it is determined that the location of the white space device is within the area served by the first database, the at least one memory and stored computer program code are configured, with the at least one processor, to additionally cause the apparatus of this example embodiment to cause an indication of available frequency spectrum at the location of the white space device to be provided to the white space device. In an instance in which it is determined that the location of the white space device is not within the area served by the first database, the at least one memory and stored computer program code are configured, with the at least one processor, to also cause the apparatus of this example embodiment to determine a second database serving an area including the location of the white space device and cause access information for the second database to be provided to the white space device.

In another example embodiment, a computer program product is provided. The computer program product of this example embodiment includes at least one computer-readable storage medium having computer-readable program instructions stored therein. The program instructions of this example embodiment comprise program instructions configured to cause receipt, at a database apparatus configured to provide access to a first database, of a query originated by a white space device for an indication of available frequency spectrum at a location of the white space device. The program instructions of this example embodiment further comprise program instructions configured to determine whether the location of the white space device is within an area served by the first database. The program instructions of this example embodiment additionally comprise program instructions configured, in an instance in which it is determined that the location of the white space device is within the area served by the first database, to cause an indication of available frequency spectrum at the location of the white space device to be provided to the white space device. The program instructions of this example embodiment also comprise program instructions configured, in an instance in which it is determined that the location of the white space device is not within the area served by the first database, to determine a second database serving an area including the location of the white space device and cause access information for the second database to be provided to the white space device.

In another example embodiment, an apparatus is provided that comprises means for receiving a query originated by a white space device for an indication of available frequency spectrum at a location of the white space device. The apparatus of this example embodiment further comprises means determining whether the location of the white space device is within an area served by a first database. The apparatus of this example embodiment also comprises means for, in an instance in which it is determined that the location of the white space device is within the area served by the first database, causing an indication of available frequency spectrum at the location of the white space device to be provided to the white space device. The apparatus of this example embodiment additionally comprises means for, in an instance in which it is determined that the location of the white space device is not within the area served by the first database, determining a second database serving an area including the location of the white space device and causing access information for the second database to be provided to the white space device.

In another example embodiment, a method is provided, which comprises receiving, at a database apparatus configured to provide access to a first database, a query originated by a white space device for an indication of available frequency spectrum at a location of the white space device. The method of this example embodiment further comprises determining, based at least in part on a location of the white space device, whether a transmission interference zone of the white space device extends into an area served by a second database. In an instance in which it is determined that the transmission interference zone of the white space device does not extend into an area served by a second database, the method of this example embodiment additionally comprises determining available frequency spectrum at the location of the white space device based on the first database. In an instance in which it is determined that the transmission interference zone of the white space device extends into an area served by a second database, the method of this example embodiment also comprises consulting the second database to determine available frequency spectrum at the location of the white space device based on both the first database and the second database. The method of this example embodiment further comprises causing an indication of the determined available frequency spectrum to be provided to the white space device.

In another example embodiment, an apparatus comprising at least one processor and at least one memory storing computer program code is provided. The at least one memory and stored computer program code are configured, with the at least one processor, to cause the apparatus of this example embodiment to at least receive a query of a first database originated by a white space device for an indication of available frequency spectrum at a location of the white space device. The at least one memory and stored computer program code are configured, with the at least one processor, to further cause the apparatus of this example embodiment to determine, based at least in part on a location of the white space device, whether a transmission interference zone of the white space device extends into an area served by a second database. In an instance in which it is determined that the transmission interference zone of the white space device does not extend into an area served by a second database, the at least one memory and stored computer program code are configured, with the at least one processor, to additionally cause the apparatus of this example embodiment to determine available frequency spectrum at the location of the white space device based on the first database. In an instance in which it is determined that the transmission interference zone of the white space device extends into an area served by a second database, the at least one memory and stored computer program code are configured, with the at least one processor, to also cause the apparatus of this example embodiment to consult the second database to determine available frequency spectrum at the location of the white space device based on both the first database and the second database. The at least one memory and stored computer program code are configured, with the at least one processor, to further cause the apparatus of this example embodiment to cause an indication of the determined available frequency spectrum to be provided to the white space device.

In another example embodiment, a computer program product is provided. The computer program product of this example embodiment includes at least one computer-readable storage medium having computer-readable program instructions stored therein. The program instructions of this example embodiment comprise program instructions configured to cause receipt, at a database apparatus configured to provide access to a first database, of a query originated by a white space device for an indication of available frequency spectrum at a location of the white space device. The program instructions of this example embodiment further comprise program instructions configured to determine, based at least in part on a location of the white space device, whether a transmission interference zone of the white space device extends into an area served by a second database. The program instructions of this example embodiment additionally comprise program instructions configured, in an instance in which it is determined that the transmission interference zone of the white space device does not extend into an area served by a second database, to determine available frequency spectrum at the location of the white space device based on the first database. The program instructions of this example embodiment also comprise program instructions configured, in an instance in which it is determined that the transmission interference zone of the white space device extends into an area served by a second database, to consult the second database to determine available frequency spectrum at the location of the white space device based on both the first database and the second database. The program instructions of this example embodiment further comprise program instructions configured to cause an indication of the determined available frequency spectrum to be provided to the white space device.

In another example embodiment, an apparatus is provided that comprises means for receiving a query of a first database originated by a white space device for an indication of available frequency spectrum at a location of the white space device. The apparatus of this example embodiment further comprises means for determining, based at least in part on a location of the white space device, whether a transmission interference zone of the white space device extends into an area served by a second database. The apparatus of this example embodiment additionally comprises means for, in an instance in which it is determined that the transmission interference zone of the white space device does not extend into an area served by a second database, determining available frequency spectrum at the location of the white space device based on the first database. The apparatus of this example embodiment also comprises means for, in an instance in which it is determined that the transmission interference zone of the white space device extends into an area served by a second database, consulting the second database to determine available frequency spectrum at the location of the white space device based on both the first database and the second database. The apparatus of this example embodiment further comprises means for causing an indication of the determined available frequency spectrum to be provided to the white space device.

In another example embodiment, a method is provided, which comprises causing a query of a first database for an indication of available frequency spectrum at a location of a white space device to be sent to a database apparatus configured to provide access to the first database. The method of this example embodiment further comprises, in an instance in which the location of the white space device is within an area served by the first database, receiving an indication of available frequency spectrum at the location of the white space device. The method of this example embodiment additionally comprises, in an instance in which the location of the white space device is not within the area served by the first database, receiving access information for a second database. The second database of this example embodiment serves an area including the location of the white space device.

In another example embodiment, an apparatus comprising at least one processor and at least one memory storing computer program code is provided. The at least one memory and stored computer program code are configured, with the at least one processor, to cause the apparatus of this example embodiment to at least cause a query of a first database for an indication of available frequency spectrum at a location of the apparatus to be sent to a database apparatus configured to provide access to the first database. The at least one memory and stored computer program code are configured, with the at least one processor, to further cause the apparatus of this example embodiment, in an instance in which the location of the apparatus is within an area served by the first database, to receive an indication of available frequency spectrum at the location of the apparatus. The at least one memory and stored computer program code are configured, with the at least one processor, to additionally cause the apparatus of this example embodiment, in an instance in which the location of the apparatus is not within the area served by the first database, to receive access information for a second database. The second database of this example embodiment serves an area including the location of the apparatus.

In another example embodiment, a computer program product is provided. The computer program product of this example embodiment includes at least one computer-readable storage medium having computer-readable program instructions stored therein.

The program instructions of this example embodiment comprise program instructions configured to cause a query of a first database for an indication of available frequency spectrum at a location of a white space device to be sent to a database apparatus configured to provide access to the first database. The program instructions of this example embodiment further comprise program instructions configured, in an instance in which the location of the white space device is within an area served by the first database, to cause receipt of an indication of available frequency spectrum at the location of the white space device. The program instructions of this example embodiment additionally comprise program instructions configured, in an instance in which the location of the white space device is not within the area served by the first database, to cause receipt of access information for a second database. The second database of this example embodiment serves an area including the location of the white space device.

In another example embodiment, an apparatus is provided that comprises means for causing a query of a first database for an indication of available frequency spectrum at a location of the apparatus to be sent to a database apparatus configured to provide access to the first database. The apparatus of this example embodiment further comprises means for, in an instance in which the location of the apparatus is within an area served by the first database, receiving an indication of available frequency spectrum at the location of the apparatus. The apparatus of this example embodiment additionally comprises means for, in an instance in which the location of the apparatus is not within the area served by the first database, receiving access information for a second database. The second database of this example embodiment serves an area including the location of the apparatus.

In another example embodiment, a method is provided, which comprises causing a query of a first database for an indication of available frequency spectrum at a location of a white space device to be sent to a database apparatus configured to provide access to the first database. The method of this example embodiment further comprises, in an instance in which a transmission interference zone of the white space device does not extend into an area served by a second database, receiving an indication of available frequency spectrum at the location of the white space device having been determined based on the first database. The method of this example embodiment also comprises, in an instance in which the transmission interference zone of the white space device does extend into an area served by a second database, receiving an indication of available frequency spectrum at the location of the white space device having been determined based on both the first database and the second database.

In another example embodiment, an apparatus comprising at least one processor and at least one memory storing computer program code is provided. The at least one memory and stored computer program code are configured, with the at least one processor, to cause the apparatus of this example embodiment to at least cause a query of a first database for an indication of available frequency spectrum at a location of the apparatus to be sent to a database apparatus configured to provide access to the first database. The at least one memory and stored computer program code are configured, with the at least one processor, to further cause the apparatus of this example embodiment, in an instance in which a transmission interference zone of the apparatus does not extend into an area served by a second database, to receive an indication of available frequency spectrum at the location of the apparatus having been determined based on the first database. The at least one memory and stored computer program code are configured, with the at least one processor, to additionally cause the apparatus of this example embodiment, in an instance in which the transmission interference zone of the apparatus does extend into an area served by a second database, to receive an indication of available frequency spectrum at the location of the apparatus having been determined based on both the first database and the second database.

In another example embodiment, a computer program product is provided. The computer program product of this example embodiment includes at least one computer-readable storage medium having computer-readable program instructions stored therein. The program instructions of this example embodiment comprise program instructions configured to cause a query of a first database for an indication of available frequency spectrum at a location of a white space device to be sent to a database apparatus configured to provide access to the first database. The program instructions of this example embodiment further comprise program instructions configured, in an instance in which a transmission interference zone of the white space device does not extend into an area served by a second database, to cause receipt of an indication of available frequency spectrum at the location of the white space device having been determined based on the first database. The program instructions of this example embodiment also comprise program instructions configured, in an instance in which the transmission interference zone of the white space device does extend into an area served by a second database, to cause receipt of an indication of available frequency spectrum at the location of the white space device having been determined based on both the first database and the second database.

In another example embodiment, an apparatus is provided that comprises means for causing a query of a first database for an indication of available frequency spectrum at a location of the apparatus to be sent to a database apparatus configured to provide access to the first database. The apparatus of this example embodiment further comprises means for, in an instance in which a transmission interference zone of the apparatus does not extend into an area served by a second database, receiving an indication of available frequency spectrum at the location of the apparatus having been determined based on the first database. The apparatus of this example embodiment additionally comprises means for, in an instance in which the transmission interference zone of the apparatus does extend into an area served by a second database, receiving an indication of available frequency spectrum at the location of the apparatus having been determined based on both the first database and the second database.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWING(S)

Having thus described embodiments of the invention in general terms, reference will now be made to the accompanying drawings, which are not necessarily drawn to scale, and wherein:

FIG. 1 illustrates a system for facilitating determination of available spectrum according to an example embodiment;

FIG. 2 is a schematic block diagram of a mobile terminal according to an example embodiment;

FIG. 3 illustrates a block diagram of a white space device according to an example embodiment;

FIG. 4 illustrates a block diagram of a database apparatus according to an example embodiment;

FIG. 5 illustrates determination of available spectrum for a roaming white space device according to an example embodiment;

FIG. 6 illustrates determination of available spectrum for a white space device located in a border region according to an example embodiment;

FIG. 7 illustrates a flowchart according to an example method for facilitating determination of available spectrum according to an example embodiment;

FIG. 8 illustrates a flowchart according to an example method for facilitating determination of available spectrum according to an example embodiment;

FIG. 9 illustrates a flowchart according to an example method for facilitating determination of available spectrum according to an example embodiment;

FIG. 10 illustrates a flowchart according to an example method for facilitating determination of available spectrum according to an example embodiment; and

FIG. 11 illustrates a flowchart according to an example method for facilitating determination of available spectrum according to an example embodiment.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like.

The term “computer-readable medium” as used herein refers to any medium configured to participate in providing information to a processor, including instructions for execution. Such a medium may take many forms, including, but not limited to a non-transitory computer-readable storage medium (for example, non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of computer-readable media include a floppy disk, a flexible disk, hard disk, magnetic tape, any other magnetic medium, a compact disc read only memory (CD-ROM), compact disc compact disc-rewritable (CD-RW), digital versatile disc (DVD), Blu-Ray, any other optical medium, punch cards, paper tape, optical mark sheets, any other physical medium with patterns of holes or other optically recognizable indicia, a random access memory (RAM), a programmable read only memory (PROM), an erasable programmable read only memory (EPROM), a FLASH-EPROM, any other memory chip or cartridge, a carrier wave, or any other medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

A white space device may query a white space database to discover the available spectrum in the location of the device. In this regard, the white space database may store records of used and/or unused frequencies for a plurality of locations in an area served by the white space database. The area served by the white space database may, for example, be a country or jurisdiction in which a national regulatory authority (for example, the FCC, CEPT, or the like) is tasked with regulating and/or licensing frequency spectrum usage. Accordingly, the white space database may be maintained by such a national regulatory authority or at least contain data reflecting the frequency spectrum regulations and/or licenses issued by such a national regulatory authority.

A white space device may encounter roaming situations wherein a user of the white space device user is visiting another country and the white space device is in an area served by a white space database other than the “home” white space database for the white space device. Accordingly, if a white space device is roaming, the white space device and/or user thereof may need to know the database serving the area in which the white space device is located in order to determine the available frequency spectrum at the white space device's location.

Further, in some instances, a white space device may be located within a border region of a first area (for example, within a predefined distance of a border of the first area) served by a first white space database wherein a transmission interference zone of the white space device may extend across the border into a second area served by a second white space database. In this regard, while the first database may be able to provide information on available (for example, unallocated and/or unused) frequencies at the location of the white space device in the first area, transmission on one or more of the available frequencies by the white space device may interfere with incumbent traffic across the border in the second area if an available frequency is used in a portion of the second area that is within the transmission interference zone of the white space device. In order to avoid this problem, some regulatory authorities, such as the FCC have imposed blackout zones in border regions where white space devices are not allowed to operate.

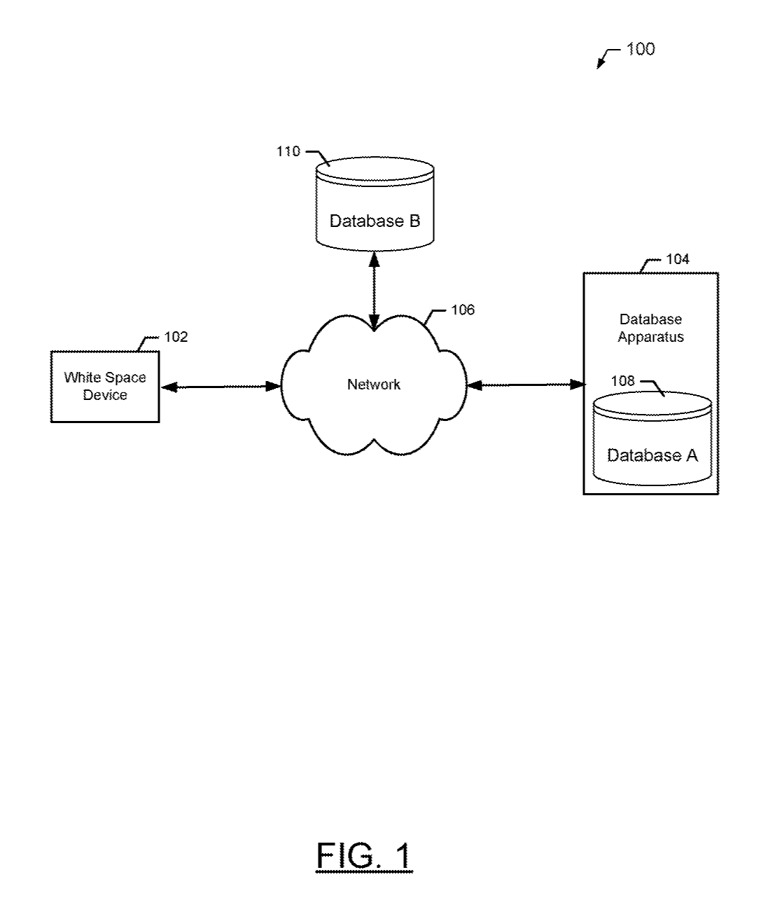

Various example embodiments disclosed herein may facilitate the determination of available frequency spectrum. Some example embodiments may be particularly beneficial in instances wherein a white space device is roaming and/or in situations wherein a white space device is located within a border region. Referring now to FIG. 1, FIG. 1 illustrates a block diagram of a system 100 for facilitating determination of available spectrum according to an example embodiment. It will be appreciated that the system 100 as well as the illustrations in other figures are each provided as an example of one embodiment and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for facilitating determination of available spectrum, numerous other configurations may also be used to implement embodiments of the present invention.

In at least some embodiments, the system 100 includes a white space device 102 and database apparatus 104. The white space device 102 and database apparatus 104 may be configured to communicate over the network 106. The network 106 may comprise one or more wireless networks (for example, a cellular network, wireless local area network, wireless personal area network, wireless metropolitan area network, and/or the like), one or more wireline networks, or some combination thereof, and in some embodiments comprises at least a portion of the internet.

The white space device 102 may be embodied as any computing device, such as, for example, a desktop computer, laptop computer, mobile terminal, mobile computer, mobile phone, mobile communication device, game device, digital camera/camcorder, audio/video player, television device, radio receiver, digital video recorder, positioning device, wrist watch, portable digital assistant (PDA), any combination thereof, and/or the like. In this regard, the white space device 102 may be embodied as any computing device configured to receive and/or transmit data using white spaces in the frequency spectrum and communicate with the database apparatus 104 over the network 106, in accordance with one or more of the embodiments described further herein below.

The database apparatus 104 may be embodied as one or more servers, a server cluster, a cloud computing infrastructure, one or more desktop computers, one or more laptop computers, one or more mobile computers, one or more network nodes, multiple computing devices in communication with each other, any combination thereof, and/or the like. More particularly, the database apparatus 104 may comprise any computing device or plurality of computing devices configured to communicate with a white space device 102 over the network 106 and provide access to the database A 108, which may be stored on the database apparatus 104. It will be appreciated, however, that while the database A 108 is stored on the database apparatus 104 in some embodiments and is illustrated in FIG. 1 as being internal to the database apparatus 104, the database A 108 may be stored on an entity external to the database apparatus 104 in some alternative embodiments. In such alternative embodiments, the database apparatus 104 may, for example, serve as a gateway configured to provide access to the database A 108.

The database A 108 may comprise a white space database storing records of available and/or unavailable frequencies at one or more locations in an area served by the database A 108. Allocation and/or regulation of frequencies in the area served by the database A 108 may be handled by a national regulatory authority, such as the FCC. Accordingly, the database A 108 may be maintained by such a national regulatory authority or at least contain data reflecting the frequency spectrum regulations and/or licenses issued by such a national regulatory authority.

The system 100 may further comprise one or more white space databases in addition to database A. One such additional white space database, the database B 110, is illustrated in FIG. 1. It will be appreciated, however, that the single database B 110 is illustrated merely for purposes of example and the system 100 may comprise a plurality of such additional databases. The database B 110 may store records of available and/or unavailable frequencies at one or more locations in the area served by the database B. The database B 110 may serve an area other than the area served by database A 108. The area served by the database B 110 may be regulated by a different national regulatory authority than a national regulatory authority that may regulate the area served by the database A 108. As such, the database B 110 may be maintained by a national regulatory authority responsible for regulating frequency usage in the area served by the database B 110 or at least contain data reflecting the frequency spectrum regulations and/or licenses issued by the national regulatory authority responsible for regulating the area served by the database B 110. Access to the database B 110 may be provided by another database apparatus, which may be embodied similarly to the database apparatus 104. Alternatively, the database apparatus 104 may be configured to provide access to a plurality of white space databases, including both the database A 108 and the database B 110.

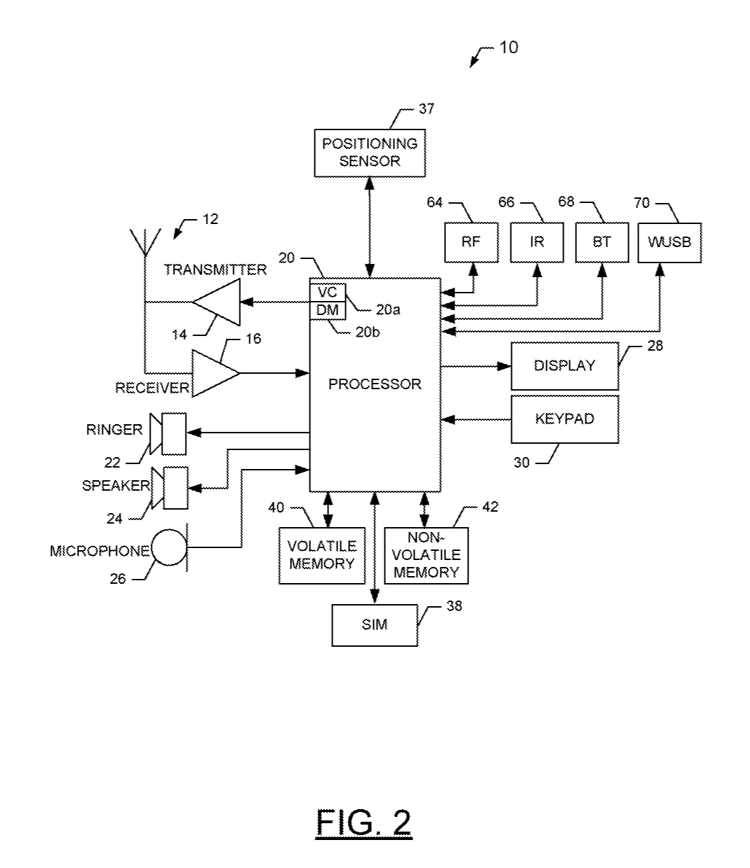

In an example embodiment, the white space device 102 is embodied as a mobile terminal, such as that illustrated in FIG. 2. In this regard, FIG. 2 illustrates a block diagram of a mobile terminal 10 representative of one embodiment of a white space device 102. It should be understood, however, that the mobile terminal 10 illustrated and hereinafter described is merely illustrative of one type of white space device 102 that may implement and/or benefit from various embodiments and, therefore, should not be taken to limit the scope of the disclosure. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (for example, session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (for example, digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (for example, software and/or firmware) stored on a memory accessible to the processor 20 (for example, volatile memory 40, non-volatile memory 42, and/or the like). Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (for example, Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wi-Fi, WLAN techniques such as IEEE 802.11 techniques, IEEE 802.15 techniques, IEEE 802.16 techniques, and/or the like.

The mobile terminal 10 may further include a positioning sensor 37. The positioning sensor 37 may include, for example, a global positioning system (GPS) sensor, an assisted global positioning system (Assisted-GPS) sensor, etc. In one embodiment, however, the positioning sensor 37 includes a pedometer or inertial sensor. Further, the positioning sensor may determine the location of the mobile terminal 10 based upon signal triangulation or other mechanisms. The positioning sensor 37 may be configured to determine a location of the mobile terminal 10, such as latitude and longitude coordinates of the mobile terminal 10 or a position relative to a reference point such as a destination or a start point. Information from the positioning sensor 37 may be communicated to a memory of the mobile terminal 10 or to another memory device to be stored as a position history or location information. Furthermore, the memory of the mobile terminal 10 may store instructions for determining cell id information. In this regard, the memory may store an application program for execution by the processor 20, which may determine an identity of the current cell (for example, cell id identity or cell id information) with which the mobile terminal 10 is in communication. In conjunction with the positioning sensor 37, the cell id information may be used to more accurately determine a location of the mobile terminal 10.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (for example, hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

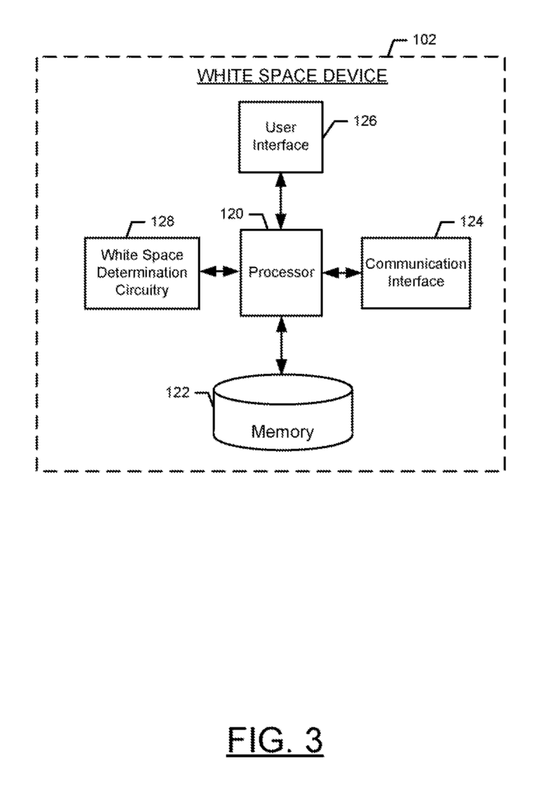

Referring now to FIG. 3, FIG. 3 illustrates a block diagram of a white space device 102 according to an example embodiment. In the example embodiment, the white space device 102 includes various means for performing the various functions herein described. These means may comprise one or more of a processor 120, memory 122, communication interface 124, user interface 126, or white space determination circuitry 128. The means of the white space device 102 as described herein may be embodied as, for example, circuitry, hardware elements (for example, a suitably programmed processor, combinational logic circuit, and/or the like), a computer program product comprising computer-readable program instructions (for example, software or firmware) stored on a computer-readable medium (for example memory 122) that is executable by a suitably configured processing device (for example, the processor 120), or some combination thereof.

In some example embodiments, one or more of the means illustrated in FIG. 3 may be embodied as a chip or chip set. In other words, the white space device 102 may comprise one or more physical packages (for example, chips) including materials, components and/or wires on a structural assembly (for example, a baseboard). The structural assembly may provide physical strength, conservation of size, and/or limitation of electrical interaction for component circuitry included thereon. In this regard, the processor 120, memory 122, communication interface 124, user interface 126, and/or white space determination circuitry 128 may be embodied as a chip or chip set. The white space device 102 may therefore, in some example embodiments, be configured to implement embodiments of the present invention on a single chip or as a single “system on a chip.” As another example, in some example embodiments, the white space device 102 may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 120 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 3 as a single processor, in some embodiments the processor 120 comprises a plurality of processors. The plurality of processors may be in operative communication with each other and may be collectively configured to perform one or more functionalities of the white space device 102 as described herein. The plurality of processors may be embodied on a single computing device or distributed across a plurality of computing devices collectively configured to function as the white space device 102. In embodiments wherein the white space device 102 is embodied as a mobile terminal 10, the processor 120 may be embodied as or comprise the processor 20. In some example embodiments, the processor 120 is configured to execute instructions stored in the memory 122 or otherwise accessible to the processor 120. These instructions, when executed by the processor 120, may cause the white space device 102 to perform one or more of the functionalities of the white space device 102 as described herein. As such, whether configured by hardware or software methods, or by a combination thereof, the processor 120 may comprise an entity capable of performing operations according to embodiments of the present invention while configured accordingly. Thus, for example, when the processor 120 is embodied as an ASIC, FPGA or the like, the processor 120 may comprise specifically configured hardware for conducting one or more operations described herein. Alternatively, as another example, when the processor 120 is embodied as an executor of instructions, such as may be stored in the memory 122, the instructions may specifically configure the processor 120 to perform one or more algorithms and operations described herein.

The memory 122 may comprise, for example, volatile memory, non-volatile memory, or some combination thereof. In this regard, the memory 122 may comprise a non-transitory computer-readable storage medium. Although illustrated in FIG. 3 as a single memory, the memory 122 may comprise a plurality of memories. The plurality of memories may be embodied on a single computing device or may be distributed across a plurality of computing devices collectively configured to function as the white space device 102. In various example embodiments, the memory 122 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the white space device 102 is embodied as a mobile terminal 10, the memory 122 may comprise the volatile memory 40 and/or the non-volatile memory 42. The memory 122 may be configured to store information, data, applications, instructions, or the like for enabling the white space device 102 to carry out various functions in accordance with various example embodiments. For example, in some example embodiments, the memory 122 is configured to buffer input data for processing by the processor 120. Additionally or alternatively, the memory 122 may be configured to store program instructions for execution by the processor 120. The memory 122 may store information in the form of static and/or dynamic information. This stored information may be stored and/or used by the white space determination circuitry 128 during the course of performing its functionalities.

The communication interface 124 may be embodied as any device or means embodied in circuitry, hardware, a computer program product comprising computer readable program instructions stored on a computer readable medium (for example, the memory 122) and executed by a processing device (for example, the processor 120), or a combination thereof that is configured to receive and/or transmit data from/to another computing device. In an example embodiment, the communication interface 124 is at least partially embodied as or otherwise controlled by the processor 120. In this regard, the communication interface 124 may be in communication with the processor 120, such as via a bus. The communication interface 124 may include, for example, an antenna, a transmitter, a receiver, a transceiver and/or supporting hardware or software for enabling communications with one or more remote computing devices. The communication interface 124 may be configured to receive and/or transmit data using any protocol that may be used for communications between computing devices. In this regard, the communication interface 124 may be configured to receive and/or transmit data using any protocol that may be used for transmission of data over a wireless network, wireline network, some combination thereof, or the like by which the white space device 102 and one or more computing devices or computing resources may be in communication. As an example, the communication interface 124 may be configured to communicate with a database apparatus 104 and/or a white space database (for example, the database A 108 and/or database B 110) over a network (for example, the network 106). The communication interface 124 may additionally be in communication with the memory 122, user interface 126, and/or white space determination circuitry 128, such as via a bus.

The user interface 126 may be in communication with the processor 120 to receive an indication of a user input and/or to provide an audible, visual, mechanical, or other output to a user. As such, the user interface 126 may include, for example, a keyboard, a mouse, a joystick, a display, a touch screen display, a microphone, a speaker, and/or other input/output mechanisms. In embodiments wherein the user interface 126 comprises a touch screen display, the user interface 126 may additionally be configured to detect and/or receive indication of a touch gesture or other input to the touch screen display. The user interface 126 may be in communication with the memory 122, communication interface 124, and/or white space determination circuitry 128, such as via a bus.

The white space determination circuitry 128 may be embodied as various means, such as circuitry, hardware, a computer program product comprising computer readable program instructions stored on a computer readable medium (for example, the memory 122) and executed by a processing device (for example, the processor 120), or some combination thereof and, in some embodiments, is embodied as or otherwise controlled by the processor 120. In embodiments wherein the white space determination circuitry 128 is embodied separately from the processor 120, the white space determination circuitry 128 may be in communication with the processor 120. The white space determination circuitry 128 may further be in communication with one or more of the memory 122, communication interface 124, or user interface 126, such as via a bus.

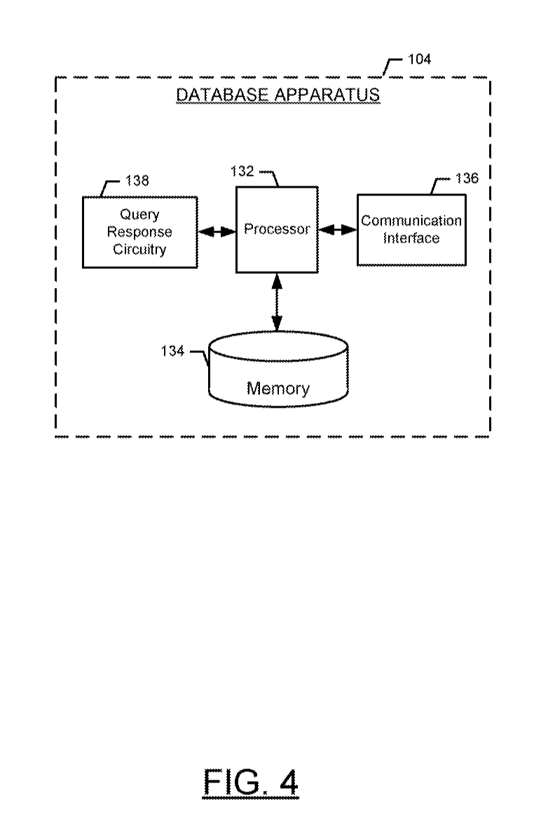

FIG. 4 illustrates a block diagram of a database apparatus 104 according to an example embodiment. In the example embodiment, the database apparatus 104 includes various means for performing the various functions herein described. These means may comprise one or more of a processor 132, memory 134, communication interface 136, or query response circuitry 138. The means of the database apparatus 104 as described herein may be embodied as, for example, circuitry, hardware elements (for example, a suitably programmed processor, combinational logic circuit, and/or the like), a computer program product comprising computer-readable program instructions (for example, software or firmware) stored on a computer-readable medium (for example memory 134) that is executable by a suitably configured processing device (for example, the processor 132), or some combination thereof.

In some example embodiments, one or more of the means illustrated in FIG. 4 may be embodied as a chip or chip set. In other words, the database apparatus 104 may comprise one or more physical packages (for example, chips) including materials, components and/or wires on a structural assembly (for example, a baseboard). The structural assembly may provide physical strength, conservation of size, and/or limitation of electrical interaction for component circuitry included thereon. In this regard, the processor 132, memory 134, communication interface 136, and/or query response circuitry 138 may be embodied as a chip or chip set. The database apparatus 104 may therefore, in some example embodiments, be configured to implement embodiments of the present invention on a single chip or as a single “system on a chip.” As another example, in some example embodiments, the database apparatus 104 may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 132 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 4 as a single processor, in some embodiments the processor 132 comprises a plurality of processors. The plurality of processors may be in operative communication with each other and may be collectively configured to perform one or more functionalities of the database apparatus 104 as described herein. The plurality of processors may be embodied on a single computing device or distributed across a plurality of computing devices collectively configured to function as the database apparatus 104. In some example embodiments, the processor 132 is configured to execute instructions stored in the memory 134 or otherwise accessible to the processor 132. These instructions, when executed by the processor 132, may cause the database apparatus 104 to perform one or more of the functionalities of the database apparatus 104 as described herein. As such, whether configured by hardware or software methods, or by a combination thereof, the processor 132 may comprise an entity capable of performing operations according to embodiments of the present invention while configured accordingly. Thus, for example, when the processor 132 is embodied as an ASIC, FPGA or the like, the processor 132 may comprise specifically configured hardware for conducting one or more operations described herein. Alternatively, as another example, when the processor 132 is embodied as an executor of instructions, such as may be stored in the memory 134, the instructions may specifically configure the processor 132 to perform one or more algorithms and operations described herein.

The memory 134 may comprise, for example, volatile memory, non-volatile memory, or some combination thereof. In this regard, the memory 134 may comprise a non-transitory computer-readable storage medium. Although illustrated in FIG. 4 as a single memory, the memory 134 may comprise a plurality of memories. The plurality of memories may be embodied on a single computing device or may be distributed across a plurality of computing devices collectively configured to function as the database apparatus 104. In various example embodiments, the memory 134 may comprise a hard disk, random access memory, cache memory, flash memory, a compact disc read only memory (CD-ROM), digital versatile disc read only memory (DVD-ROM), an optical disc, circuitry configured to store information, or some combination thereof. The memory 134 may be configured to store information, data, applications, instructions, or the like for enabling the database apparatus 104 to carry out various functions in accordance with various example embodiments. For example, in some example embodiments, the memory 134 is configured to buffer input data for processing by the processor 132. Additionally or alternatively, the memory 134 may be configured to store program instructions for execution by the processor 132. The memory 134 may store information in the form of static and/or dynamic information. The stored information may, for example, include one or more white space databases, such as the database A 108. Additionally or alternatively, the stored information may include a list of white space databases and access information for accessing the white space databases. This stored information may be stored and/or used by the query response circuitry 138 during the course of performing its functionalities.

The communication interface 136 may be embodied as any device or means embodied in circuitry, hardware, a computer program product comprising computer readable program instructions stored on a computer readable medium (for example, the memory 134) and executed by a processing device (for example, the processor 132), or a combination thereof that is configured to receive and/or transmit data from/to another computing device. In an example embodiment, the communication interface 136 is at least partially embodied as or otherwise controlled by the processor 132. In this regard, the communication interface 136 may be in communication with the processor 132, such as via a bus. The communication interface 136 may include, for example, an antenna, a transmitter, a receiver, a transceiver and/or supporting hardware or software for enabling communications with one or more remote computing devices. The communication interface 136 may be configured to receive and/or transmit data using any protocol that may be used for communications between computing devices. In this regard, the communication interface 136 may be configured to receive and/or transmit data using any protocol that may be used for transmission of data over a wireless network, wireline network, some combination thereof, or the like by which the database apparatus 104 and one or more computing devices or computing resources may be in communication. As an example, the communication interface 136 may be configured to communicate with a white space device 102 and/or a white space database (for example, the database A 108 and/or database B 110) over a network (for example, the network 106). The communication interface 136 may additionally be in communication with the memory 134, and/or query response circuitry 138, such as via a bus.

The query response circuitry 138 may be embodied as various means, such as circuitry, hardware, a computer program product comprising computer readable program instructions stored on a computer readable medium (for example, the memory 134) and executed by a processing device (for example, the processor 132), or some combination thereof and, in some embodiments, is embodied as or otherwise controlled by the processor 132. In embodiments wherein the query response circuitry 138 is embodied separately from the processor 132, the query response circuitry 138 may be in communication with the processor 132. The query response circuitry 138 may further be in communication with one or more of the memory 134 or communication interface 136, such as via a bus.

In some example embodiments, the white space determination circuitry 128 is configured to cause a query of the database A 108 for the available frequency spectrum at the location of the white space device 102 to be sent to the database apparatus 104. The white space determination circuitry 128 may be configured to perform this query operation in preparation for a planned use of a white space frequency. As another example, the white space determination circuitry 128 may be configured to keep track of and periodically update the available frequency spectrum for the white space device 102 so that the white space device 102 has access to the available frequency spectrum at its current location when needing to utilize a white space frequency. As still a further example, the white space determination circuitry 128 may be configured to query the database A 108 in response to a change in location of the white space device 102, such as when the white space device 102 changes its location by more than a predefined distance from a location at which the white space determination circuitry 128 last queried for available frequency spectrum.

In some example embodiments, the white space determination circuitry 128 is configured to query a particular database by default. Thus, for purposes of example, in some example embodiments, the database A 108 may be regarded as a default database for the white space device 102. The default database for the white space device 102 may, for example, comprise a predefined preferred database for the white space device 102. In this regard, the database A 108 may, for example, comprise a pre-provisioned white space database programmed into the white space device 102 by a manufacturer of, network provider for the white space device 102, and/or the like. As another example, default database for the white space device 102 may serve the home area for the white space device 102 and thus serve as the default white space database for the white space device 102. As still a further example, the white space determination circuitry 128 may be configured to consider a previously consulted white space database (for example, the most recent database queried or the most recent database successfully queried by the white space device 102) to be the default database for the white space device 102.

The white space determination circuitry 128 may be configured to include an indication of the location of the white space device 102 in a query of a white space database. The indication of the location of the white space device 102 may, for example, comprise one or more of geo-location data identifying the location of the white space device 102, positioning coordinates, an identification of a cell (for example, a cell ID) on which the white space device 102 is camped, identification of a network access point (for example, an identification of a router, network hub, or the like) on which the white space device is camped, a network address (for example, an internet protocol address) for the white space device 102, or the like.

In embodiments wherein the white space determination circuitry 128 includes an indication of an actual position of the white space device 102, such as through inclusion of geo-location data and/or positioning data, in a query, the white space determination circuitry 128 may be configured to obtain the positioning data from a positioning sensor of the white space device 102. In this regard, while not illustrated in FIG. 3, the white space device 102 may, in some embodiments, further comprise a positioning sensor, such as the positioning sensor 37 of the mobile terminal 10. The positioning sensor may be configured to ascertain a position of the white space device 102 through GPS, assisted GPS, signal triangulation, determination of cell ID, and/or the like. As another example, the white space determination circuitry 128 may be configured to request an estimation of the location of the white space device 102 from another network entity, such as a network access point, domain name service (DNS) server, and/or the like that may be configured to provide a position estimate to a requesting device, such as the white space device 102.

The query response circuitry 138 of the database apparatus 104 may be configured to receive a query of the database A 108 sent by the white space device 102. In response to receipt of a query, the query response circuitry 138 may be configured to determine available frequency spectrum at the location of the white space device 102 based at least in part on the database A 108. In this regard, the query response circuitry 138 may be configured to resolve the query to determine the allocated/in-use frequencies at the location of the white space device 102 and/or to determine the available/unused frequencies at the location of the white space device 102 based at least in part on the contents of the database A 108. More particularly, the query response circuitry 138 may be configured to look up the location of the white space device 102 in the database A 108 to determine the corresponding available frequency spectrum at that location.

In embodiments wherein the query includes an indication of the location of the white space device 102, the query response circuitry 138 may use that indication as a basis for resolving the query. Thus, for example, where the query includes positioning data for the white space device 102, the query response circuitry 138 may be configured to use that positioning data as a basis for a query of the database A 108. In some instances, a format of positioning data included in the query may not be compatible with the formatting of the database A 108. In such instances, the query response circuitry 138 may be configured to convert the positioning data into a format suitable for resolving the query. In embodiments wherein the indication of location included in a received query comprises a network address of the white space device 102, identity of a network access point used by the white space device 102, and/or the like, the query response circuitry 138 may be configured to use that indication to determine an estimate of an absolute position of the white space device 102 for use in resolving the query, such as by consulting a DNS service, a geo-location network entity, and/or the like.

In embodiments wherein the query does not include an indication of the location of the white space device 102, the query response circuitry 138 may be configured to use any available methodology to determine a location of the white space device 102. For example, the query response circuitry 138 may be configured to determine a network address, such as an internet protocol address, of the white space device 102 during handshaking when communication takes place between the white space device 102 and database apparatus 104. The query response circuitry 138 may use the determined network address to determine a location of the white space device 102, such as by consulting a DNS service, a geo-location network entity, and/or the like.

The query response circuitry 138 may be further configured to format a query response including an indication of the determined available frequency spectrum at the location of the white space device 102. The indication of the determined available frequency spectrum may, for example, include a list of available frequencies and/or frequency bands, a list of unavailable frequencies and/or frequency bands, some combination thereof, or the like. The query response circuitry 138 may additionally be configured to cause the query response to be sent to the white space device 102 in response to the received query.

The white space determination circuitry 128 may be configured to receive a query response sent by the database apparatus 104. The white space determination circuitry 128 may be further configured to determine the available frequency spectrum at the location of the white space device 102 based at least in part upon the indication thereof included in the query response.

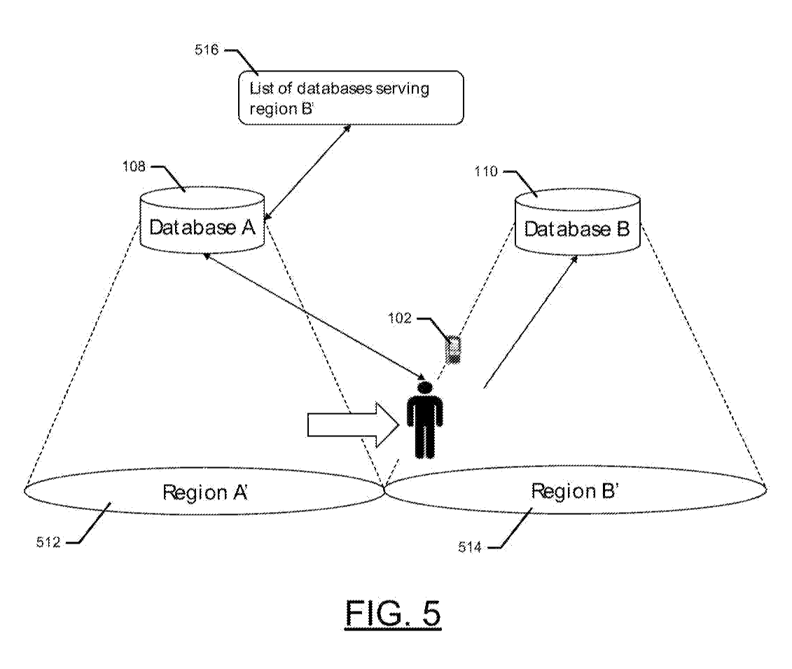

In some instances, however, the contents of the database A 108 may not be sufficient for responding to a query by the white space device 102. As an example of one such instance, the white space device 102 may be roaming to an area served by a database other than the database A 108. As such, the database A 108 may not include information on the available frequency spectrum at the location of the white space device 102. Accordingly, some example embodiments disclosed herein facilitate determination of available frequency spectrum for a roaming white space device. In this regard, FIG. 5 illustrates determination of available spectrum for a roaming white space device according to an example embodiment.

Referring now to FIG. 5, the database A 108 is illustrated to serve a region A′ 512 and the database B 110 is illustrated to serve a region B′ 514. In the example of FIG. 5, the database A 108 may serve as a default and/or home database for the white space device 102. The white space device 102 has roamed to a location in the region B′ 514. It will be appreciated that while the white space device 102 is illustrated in FIG. 5 as a mobile terminal, this illustration is merely by way of example and not by way of limitation.

The white space determination circuitry 128 may cause the white space device 102 to send a query of the database A 108 to the database apparatus 104 as previously described. In response to receipt of the query, the query response circuitry 138 may be configured to determine whether the location of the white space device is within the region A′ 512. In this regard, for example, the query response circuitry 138 may, as an initial screening matter, determine whether the location of the white space device 102 is within the region A′ 512 prior to attempting to resolve the query. Alternatively, as another example, the query response circuitry 138 may attempt to query the database A 108 for the white space device 102 in the database and if the query fails may determine that the location of the white space device 102 is not within the region A′ 512. Further, the query response circuitry 138 may be configured in some embodiments to determine that the white space device 102 is effectively outside of the region A′ 512 even if the white space device 102 is physically located in the region A′ 512 in instances wherein the white space device 102 is about to leave the region A′ 512, such as may be determined by the white space device 102 being on the edge of the region A′ 512 (for example, being within a predefined distance of the border of the region A′ 512), a direction of travel of the white space device 102, and/or the like.

In an instance, such as that illustrated in FIG. 5, where the query response circuitry 138 determines that the white space device 102 is not within the region A′ 512, the query response circuitry 138 may be configured to determine a database serving an area including the location of the white space device 102. As an example, the query response circuitry 138 may be configured to consult a list of databases, such as the list 516, to determine a database serving the location of the white space device 102. The list of databases may, for example, comprise a dynamic list which the database A 108 and/or query response circuitry 138 may maintain through interaction with other white space databases over the network 106. As another example, the list of databases may be maintained by a national regulatory authority, which may update the list through consultation with other national regulatory authorities responsible with maintaining and/or regulating white space databases.

In the example illustrated in FIG. 5, the query response circuitry 138 may determine that the database B 110 serves the area in which the white space device 102 is located. The query response circuitry 138 may be further configured to format a query response including access information for the database determined to serve the area in which the white space device 102 is located. The access information may, for example, comprise a network address, such as a hypertext transport protocol address, by which the determined database is accessible. The query response circuitry 138 may further cause the query response including the access information for the determined database to be provided to the white space device 102.

The white space determination circuitry 128 may accordingly be configured to receive a query response including access information for a white space database serving an area in which the white space device 102 is located. The white space determination circuitry 128 may be configured to use the access information to query the database serving the location of the white space device 102 for the available frequency spectrum at the location of the white space device 102. Accordingly, in the example illustrated in FIG. 5, the white space determination circuitry 128 may receive access information for the database B 110 and may use the access information to query the database B 110 for the available frequency spectrum at the location of the white space device 102 in the region B′ 514.

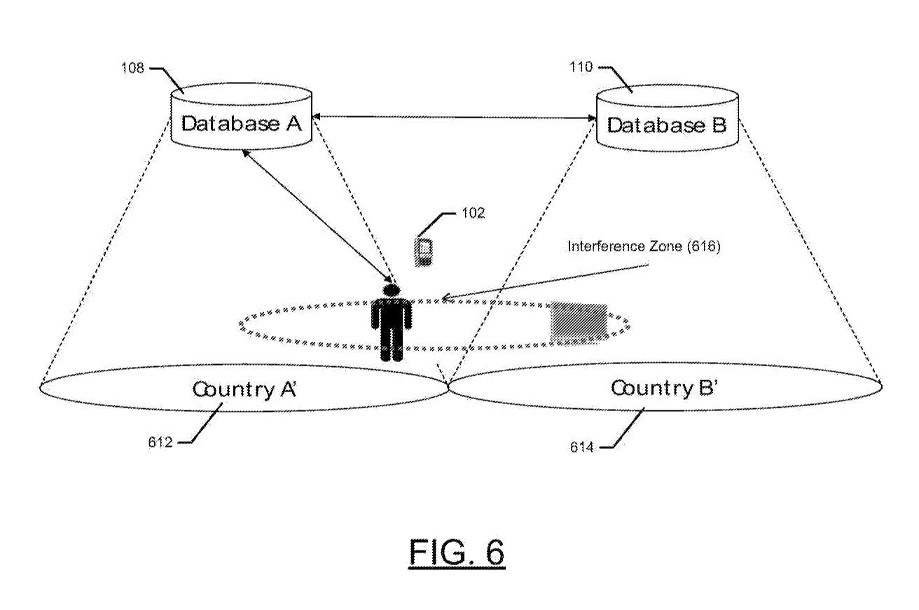

Another example wherein the contents of the database A 108 may not be sufficient for responding to a query by the white space device 102 is an instance wherein a transmission interference zone of the white space device 102 may extend into a second area served by a second database. In this regard, a white space device 102 may be located within an area served by a queried database, but may be located within a border region of the area such that transmissions by and/or interference from such transmissions by the white space device 102 may extend across the border to the second area served by the second database. Accordingly, if the white space device 102 transmits on frequencies that are available in the area served by the queried database but are used for incumbent traffic in the second area, the transmissions by the white space device 102 may interfere with the incumbent traffic. FIG. 6 illustrates determination of available spectrum for a white space device located in a border region wherein a transmission interference zone of the white space device may extend into an area served by a second database according to an example embodiment.

Referring now to FIG. 6, the database A 108 is illustrated to serve a country A′ 612 and the database B 110 is illustrated to serve a country B′ 614. In the example of FIG. 6, the database A 108 may serve as a default and/or home database for the white space device 102. The white space device 102 is located within the country A′612, but is located in a border region of the country A′ 612 bordering the country B′ 614. It will be appreciated that while the white space device 102 is illustrated in FIG. 6 as a mobile terminal, this illustration is merely by way of example and not by way of limitation. As illustrated in FIG. 6, the transmission interference zone 616 of the white space device 102 extends into country B′ 614.

The white space determination circuitry 128 may cause the white space device 102 to send a query of the database A 108 to the database apparatus 104 as previously described. In response to receipt of the query, the query response circuitry 138 may be configured to determine whether the transmission interference zone 616 of the white space device 102 extends into an area served by a second database. The query response circuitry 138 may, for example, make this determination based on a predefined interference zone radius used to determine whether the location of the white space device 102 is within the predefined interference zone radius of the border of country A′ 612. As another example, the query response circuitry 138 may be configured to determine an interference zone radius specific to the white space device 102, such as based on a type of the white space device 102, a transmission power of the white space device 102, and/or the like. The query response circuitry 138 may use the determined interference zone radius to determine whether the location of the white space device 102 is within the determined interference zone radius of the border of country A′ 612.

In an instance, such as that illustrated in FIG. 6, wherein the query response circuitry 138 determines that the transmission interference zone 616 of the white space device 102 does extend into an area served by a second database, the query response circuitry 138 may be configured to consult the second database to determine the available frequency spectrum at the location of the white space device 102. Accordingly, in the example illustrated in FIG. 6, the query response circuitry 138 may consult with the database B 110. In this regard, the query response circuitry 138 may consult with the database B 110 to determine the available frequency spectrum at the location of the white space device 102 based on the contents of both the database A 108 and the database B 110.

As an example, the query response circuitry 138 may determine based on the database A 108 a set of one or more frequencies available for use at the location of the white space device 102. The query response circuitry 138 may further provide an indication of the white space device 102 to the database B 110 so as to query the database B 110 for the available frequency spectrum at the location of the white space device 102 based on the contents of database B 110. The query response circuitry 138 may receive a response from the database B 110 and determine the available frequency spectrum at the location of the white space device 102 based on both the set of frequencies determined based on database A 108 and the response from database B 110.

In an instance in which the response from database B 110 includes an indication of one or more frequencies that must not be used in the portion of country B′ 614 that is overlapped by the transmission interference zone 616, the query response circuitry 138 may remove any of the frequencies indicated by the database B 110 that are in the set determined from database A 108 from the set. The set of frequencies resulting from removal of the prohibited frequencies determined from database B 110 represents the determined available frequency spectrum at the location of the white space device 102.

In an instance in which the response from database B 110 includes a set of one or more frequencies that are available for use at the location of the white space device 102, the query response circuitry 138 may be configured to generate a set of frequencies containing only those frequencies common to both the set determined from database A 108 and the set determined from database B 110. The resulting set of common frequencies represents the determined available frequency spectrum at the location of the white space device 102.

The query response circuitry 138 may be configured to format a query response including an indication of the available frequency spectrum determined based on both database A 108 and database B 110 and cause the database apparatus 104 to send the query response to the white space device 102. The white space determination circuitry 128 may be configured to receive the response and determine the available frequency spectrum based on the indication included in the response.

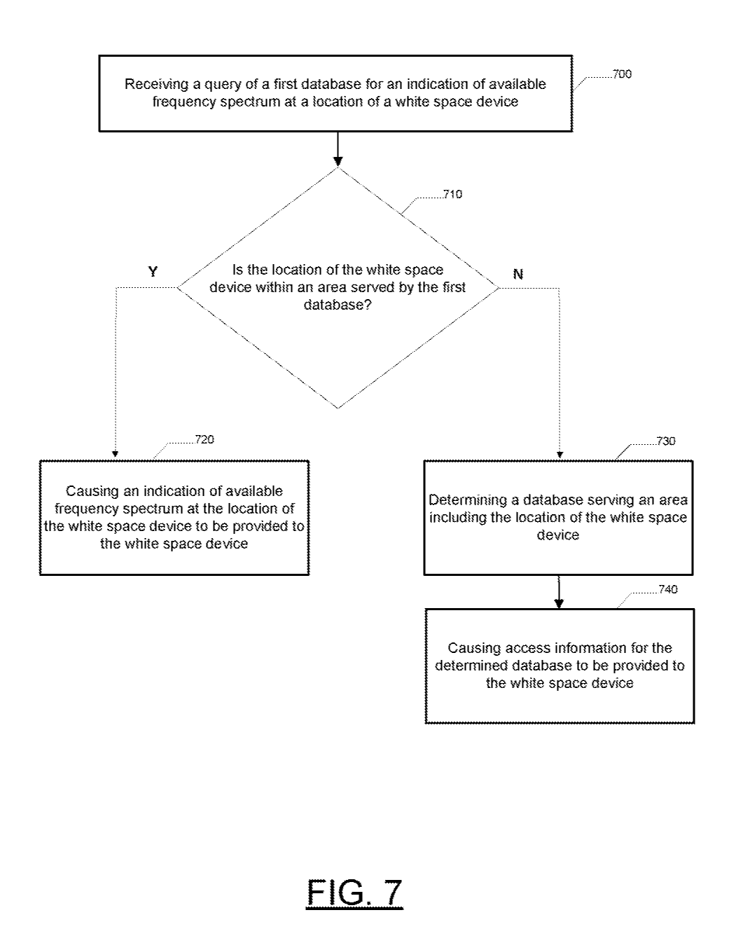

FIG. 7 illustrates a flowchart according to an example method for facilitating determination of available spectrum according to an example embodiment. In this regard, FIG. 7 illustrates operations that may be performed at the database apparatus 104. The operations illustrated in and described with respect to FIG. 7 may, for example, be performed by, with the assistance of, and/or under the control of one or more of the processor 132, memory 134, communication interface 136, or query response circuitry 138. Operation 700 may comprise receiving a query of a first database for an indication of available frequency spectrum at a location of a white space device. The processor 132, memory 134, communication interface 136, and/or query response circuitry 138 may, for example, provide means for performing operation 700. Operation 710 may comprise determining whether the location of the white space device is within an area served by the first database. The processor 132, memory 134, and/or query response circuitry 138 may, for example, provide means for performing operation 710. In an instance in which it is determined that the location of the white space device is within an area served by the first database, operation 720 may comprise causing an indication of available frequency spectrum at the location of the white space device to be provided to the white space device. The processor 132, memory 134, communication interface 136, and/or query response circuitry 138 may, for example, provide means for performing operation 720.

In an instance in which it is determined that the location of the white space device is not within an area served by the first database, operation 730 may comprise determining a database serving an area including the location of the white space device. The processor 132, memory 134, communication interface 136, and/or query response circuitry 138 may, for example, provide means for performing operation 730. Operation 740 may comprise causing access information for the determined database to be provided to the white space device. The processor 132, memory 134, communication interface 136, and/or query response circuitry 138 may, for example, provide means for performing operation 740.

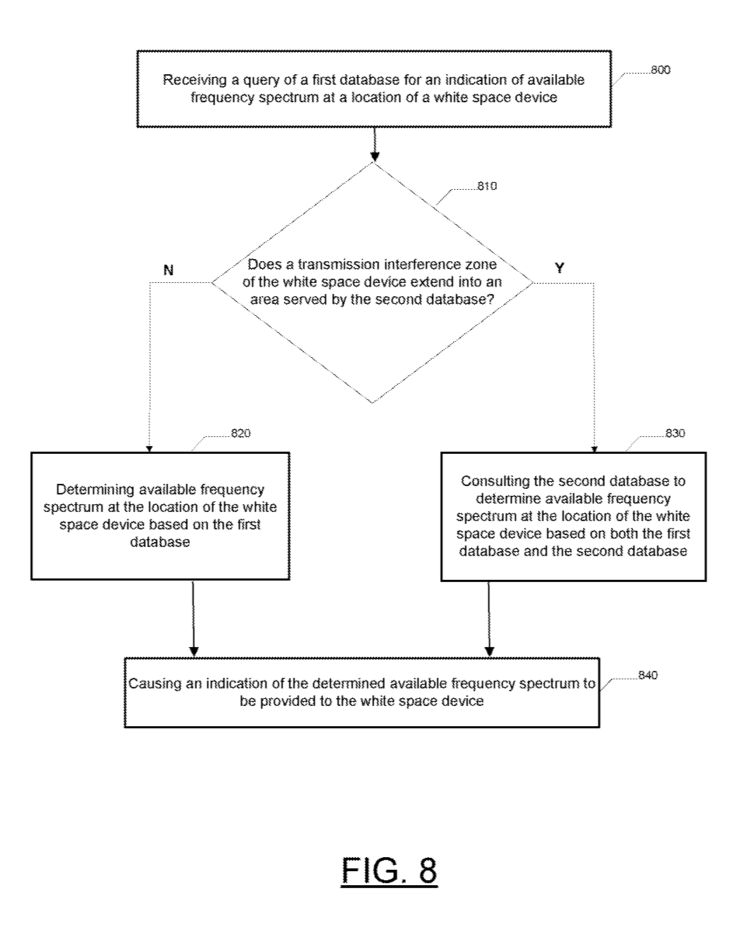

FIG. 8 illustrates a flowchart according to another example method for facilitating determination of available spectrum according to an example embodiment. In this regard, FIG. 8 illustrates operations that may be performed at the database apparatus 104. The operations illustrated in and described with respect to FIG. 8 may, for example, be performed by, with the assistance of, and/or under the control of one or more of the processor 132, memory 134, communication interface 136, or query response circuitry 138. Operation 800 may comprise receiving a query of a first database for an indication of available frequency spectrum at a location of a white space device. The processor 132, memory 134, communication interface 136, and/or query response circuitry 138 may, for example, provide means for performing operation 800. Operation 810 may comprise determining whether a transmission interference zone of the white space device extends into an area served by a second database. The processor 132, memory 134, and/or query response circuitry 138 may, for example, provide means for performing operation 810. In an instance in which it is determined at operation 810 that the transmission interference zone of the white space device does not extend into an area served by a second database, the method may proceed to operation 820, which may comprise determining available frequency spectrum at the location of the white space device based on the first database (for example, based only on the contents of the first database). The processor 132, memory 134, and/or query response circuitry 138 may, for example, provide means for performing operation 820. If, however, it is determined at operation 830 that the transmission interference zone of the white space device does extend into an area served by a second database, the method may proceed to operation 830, which may comprise consulting the second database to determine available frequency spectrum at the location of the white space device based on both the first database and the second database. The processor 132, memory 134, communication interface 136, and/or query response circuitry 138 may, for example, provide means for performing operation 830. Operation 840 may comprise causing an indication of the determined available frequency spectrum (for example, the available frequency spectrum determined in operation 820 or in operation 830) to be provided to the white space device. The processor 132, memory 134, communication interface 136, and/or query response circuitry 138 may, for example, provide means for performing operation 840.

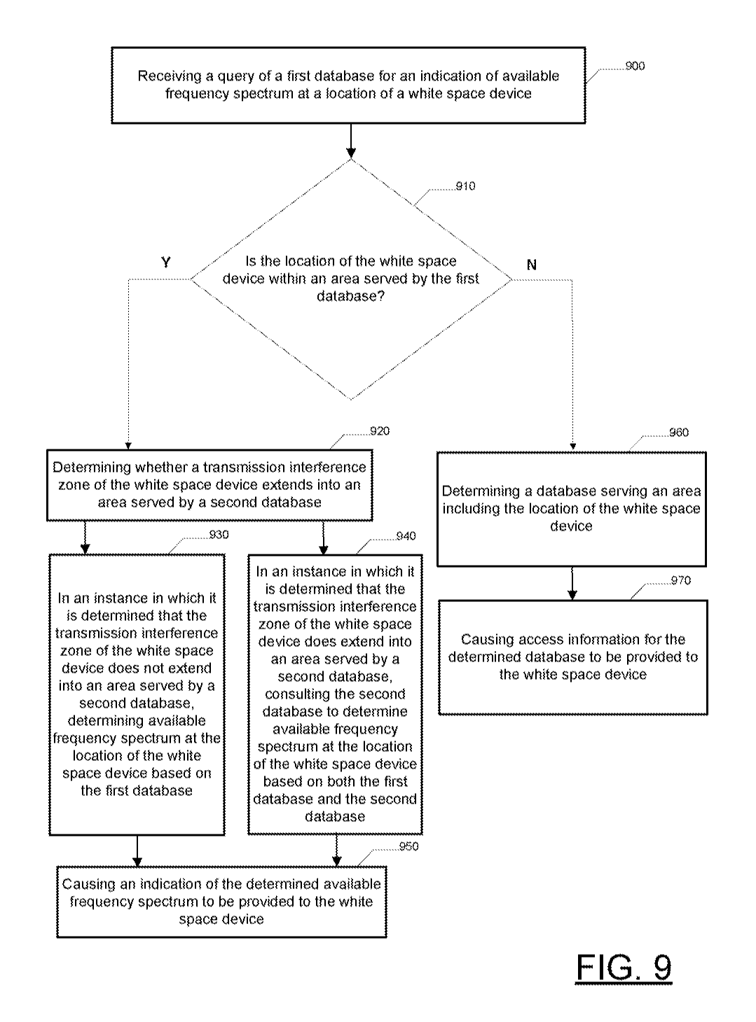

FIG. 9 illustrates a flowchart according to a further example method for facilitating determination of available spectrum according to an example embodiment. In this regard, FIG. 9 illustrates operations that may be performed at the database apparatus 104. The operations illustrated in and described with respect to FIG. 9 may, for example, be performed by, with the assistance of, and/or under the control of one or more of the processor 132, memory 134, communication interface 136, or query response circuitry 138. Operation 900 may comprise receiving a query of a first database for an indication of available frequency spectrum at a location of a white space device. The processor 132, memory 134, communication interface 136, and/or query response circuitry 138 may, for example, provide means for performing operation 900. Operation 910 may comprise determining whether the location of the white space device is within an area served by the first database. The processor 132, memory 134, and/or query response circuitry 138 may, for example, provide means for performing operation 910.

In an instance in which it is determined in operation 910 that the location of the white space device is within an area served by the first database, operation 920 may comprise determining whether a transmission interference zone of the white space device extends into an area served by a second database. The processor 132, memory 134, and/or query response circuitry 138 may, for example, provide means for performing operation 810. In an instance in which it is determined at operation 920 that the transmission interference zone of the white space device does not extend into an area served by a second database, the method may comprise operation 930, which may comprise determining available frequency spectrum at the location of the white space device based on the first database (for example, based only on the contents of the first database). The processor 132, memory 134, and/or query response circuitry 138 may, for example, provide means for performing operation 930. In an instance in which it is determined at operation 920 that the transmission interference zone of the white space device does extend into an area served by a second database, the method may comprise operation 940, which may comprise consulting the second database to determine available frequency spectrum at the location of the white space device based on both the first database and the second database. The processor 132, memory 134, communication interface 136, and/or query response circuitry 138 may, for example, provide means for performing operation 940. Operation 950 may comprise causing an indication of the determined available frequency spectrum (for example, the available frequency spectrum determined in operation 930 or in operation 940) to be provided to the white space device. The processor 132, memory 134, communication interface 136, and/or query response circuitry 138 may, for example, provide means for performing operation 950.

In an instance in which it is determined at operation 910 that the location of the white space device is not within an area served by the first database, operation 960 may comprise determining a database serving an area including the location of the white space device. The processor 132, memory 134, communication interface 136, and/or query response circuitry 138 may, for example, provide means for performing operation 960. Operation 970 may comprise causing access information for the determined database to be provided to the white space device. The processor 132, memory 134, communication interface 136, and/or query response circuitry 138 may, for example, provide means for performing operation 970.

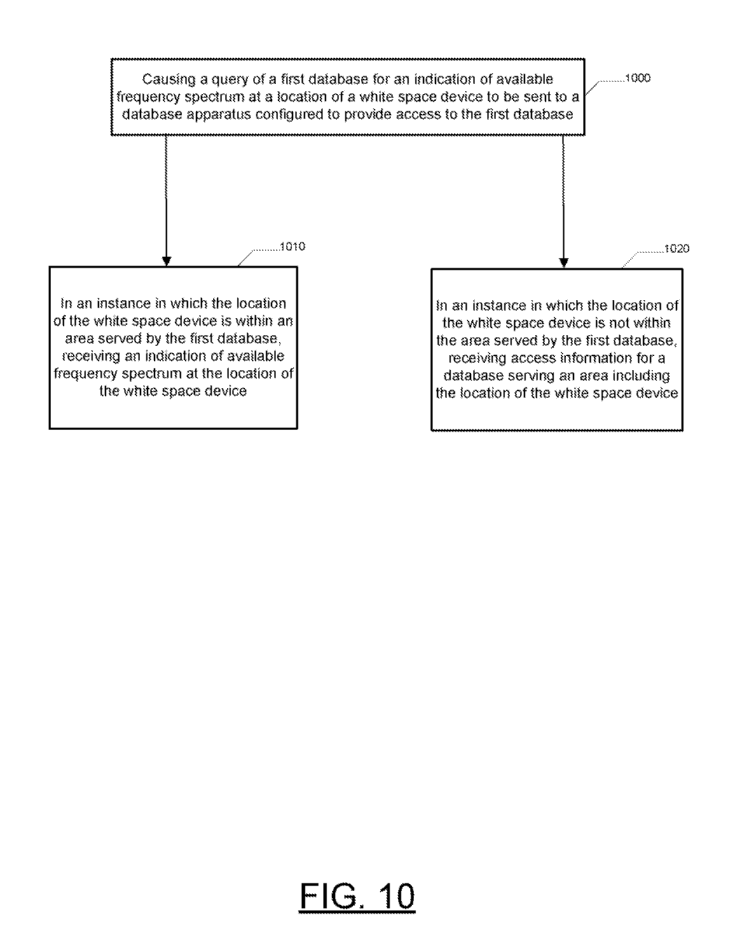

FIG. 10 illustrates a flowchart according to another example method for facilitating determination of available spectrum according to an example embodiment. In this regard, FIG. 10 illustrates operations that may be performed at the white space device 102. The operations illustrated in and described with respect to FIG. 10 may, for example, be performed by, with the assistance of, and/or under the control of one or more of the processor 120, memory 122, communication interface 124, user interface 126, or white space determination circuitry 128. Operation 1000 may comprise causing a query of a first database for an indication of available frequency spectrum at a location of a white space device to be sent to a database apparatus configured to provide access to the first database. The processor 120, memory 122, communication interface 124, user interface 126, and/or white space determination circuitry 128 may, for example, provide means for performing operation 1000. In an instance in which the location of the white space device is within an area served by the first database, the method may further comprise operation 1010, which may comprise receiving an indication of available frequency spectrum at the location of the white space device. The processor 120, memory 122, communication interface 124, and/or white space determination circuitry 128 may, for example, provide means for performing operation 1010. In an instance in which the location of the white space device is not within the area served by the first database, the method may further comprise operation 1020, which may comprise receiving access information for a database serving an area including the location of the white space device. The processor 120, memory 122, communication interface 124, and/or white space determination circuitry 128 may, for example, provide means for performing operation 1020.

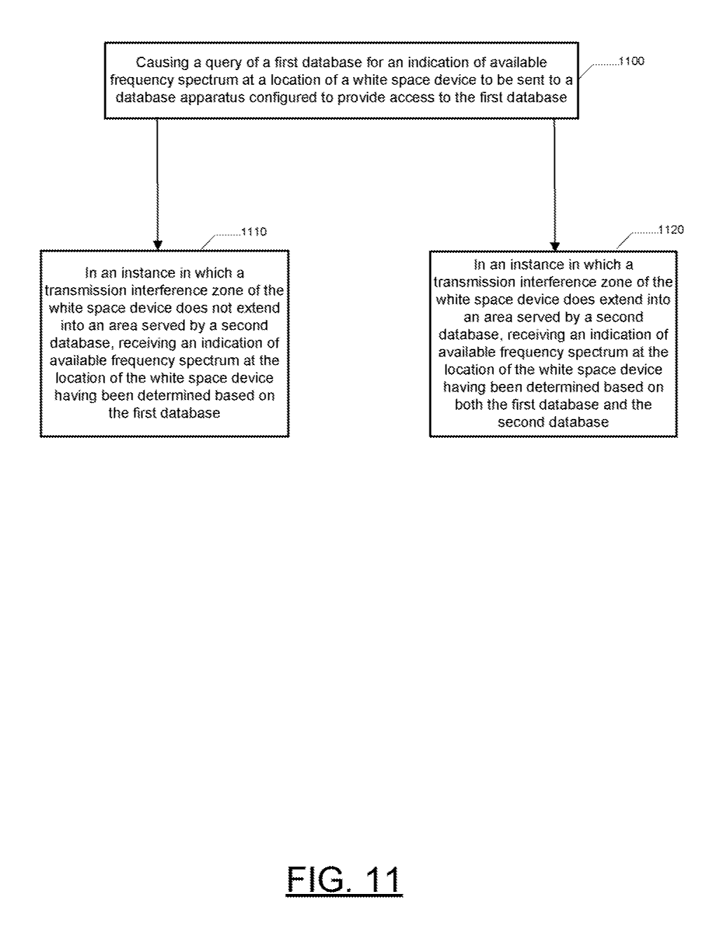

FIG. 11 illustrates a flowchart according to a further example method for facilitating determination of available spectrum according to an example embodiment. In this regard, FIG. 11 illustrates operations that may be performed at the white space device 102. The operations illustrated in and described with respect to FIG. 11 may, for example, be performed by, with the assistance of, and/or under the control of one or more of the processor 120, memory 122, communication interface 124, user interface 126, or white space determination circuitry 128. Operation 1100 may comprise causing a query of a first database for an indication of available frequency spectrum at a location of a white space device to be sent to a database apparatus configured to provide access to the first database. The processor 120, memory 122, communication interface 124, user interface 126, and/or white space determination circuitry 128 may, for example, provide means for performing operation 1100. In an instance in which a transmission interference zone of the white space device does not extend into an area served by a second database, the method may further comprise operation 1110, which may comprise receiving an indication of available frequency spectrum at the location of the white space device having been determined based on the first database (for example, based only on the contents of the first database). The processor 120, memory 122, communication interface 124, and/or white space determination circuitry 128 may, for example, provide means for performing operation 1110. In an instance in which the transmission interference zone of the white space device does extend into an area served by a second database, the method may further comprise operation 1120, which may comprise receiving an indication of available frequency spectrum at the location of the white space device having been determined based on both the first database and the second database. The processor 120, memory 122, communication interface 124, and/or white space determination circuitry 128 may, for example, provide means for performing operation 1120.

FIGS. 7-11 each illustrate a flowchart of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 122 and/or in the memory 134) and executed by a processor in the computing device (for example, by the processor 120 and/or by the processor 132). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, a white space device 102 and/or a database apparatus 104) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, a white space device 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (for example, the processor 120 and/or processor 132) may provide all or a portion of the elements. In another embodiment, all or a portion of the elements may be configured by and operate under control of a computer program product. The computer program product for performing the methods of embodiments of the invention includes a computer-readable storage medium (for example, the memory 122 and/or memory 134), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1-11. (canceled)

12. An apparatus comprising at least one processor and at least one memory storing computer program code, wherein the at least one memory and stored computer program code are configured, with the at least one processor, to cause the apparatus to at least:
receive a query originated by a white space device for an indication of available frequency spectrum at a location of the white space device;
determine whether the location of the white space device is within an area served by a first database;
in an instance in which it is determined that the location of the white space device is within the area served by the first database, cause an indication of available frequency spectrum at the location of the white space device to be provided to the white space device; and
in an instance in which it is determined that the location of the white space device is not within the area served by the first database:
determine a second database, the second database serving an area including the location of the white space device; and
cause access information for the second database to be provided to the white space device.

13-14. (canceled)

15. The apparatus according to claim 12, wherein the at least one memory and stored computer program code are configured, with the at least one processor, to cause the apparatus to determine the second database at least in part by consulting a list of databases to determine a database serving an area comprising the location of the white space device.

16. The apparatus according to claim 12, wherein the query comprises an indication of the location of the white space device.

17. The apparatus according to claim 16, wherein the indication of the location of the white space device comprises one or more of geo-location data identifying the location of the white space device, positioning coordinates, an identification of a cell on which the white space device is camped, identification of a network access point on which the white space device is camped, or an internet protocol address for the white space device.

18. The apparatus according to claim 12, wherein the first database is maintained by a first national regulatory authority of a first country and the second database is maintained by a second national regulatory authority of a second country.

19. (canceled)

20. The apparatus according to claim 12, wherein the at least one memory and stored computer program code are configured, with the at least one processor, to further cause the apparatus, in an instance in which it is determined that the location of the white space device is within the area served by the first database, to:
determine whether a transmission interference zone of the white space device extends into an area served by another database; and
in an instance in which it is determined that the transmission interference zone of the white space device extends into an area served by another database to:
consult the another database to determine available frequency spectrum at the location of the white space device based on both the first database and the another database, and
cause an indication of available frequency spectrum at the location of the white space device to be provided to the white space device by causing an indication of the determined available frequency spectrum to be provided to the white space device.

21-32. (canceled)

33. An apparatus comprising at least one processor and at least one memory storing computer program code, wherein the at least one memory and stored computer program code are configured, with the at least one processor, to cause the apparatus to at least:
receive a query of a first database, the query being originated by a white space device for an indication of available frequency spectrum at a location of the white space device;
determine, based at least in part on a location of the white space device, whether a transmission interference zone of the white space device extends into an area served by a second database;
in an instance in which it is determined that the transmission interference zone of the white space device does not extend into an area served by a second database, determine available frequency spectrum at the location of the white space device based on the first database;
in an instance in which it is determined that the transmission interference zone of the white space device extends into an area served by a second database, consult the second database to determine available frequency spectrum at the location of the white space device based on both the first database and the second database, and
cause an indication of the determined available frequency spectrum to be provided to the white space device.

34. The apparatus according to claim 33, wherein the at least one memory and stored computer program code are configured, with the at least one processor, to cause the apparatus to consult the second database to determine available frequency spectrum at the location of the white space device based on both the first database and the second database at least in part by:
determining, based on the first database, a set of one or more frequencies available for use at the location of the white space device;
causing an indication of the location of the white space device to be provided to the second database;
receiving an indication from the second database of one or more frequencies that must not be used by the white space device in a portion of the area served by the second database that is overlapped by the transmission interference zone of the white space device; and
removing any of the one or more frequencies that must not be used that are in the set from the set.

35. The apparatus according to claim 33, wherein the at least one memory and stored computer program code are configured, with the at least one processor, to cause the apparatus to consult the second database to determine available frequency spectrum at the location of the white space device based on both the first database and the second database at least in part by:
determining, based on the first database, a first set of one or more frequencies available for use at the location of the white space device;
causing an indication of the location of the white space device to be provided to the second database;
receiving an indication from the second database of a second set of one or more frequencies available for use at the location of the white space device; and
determining available frequency spectrum at the location of the white space device by determining a set of one or more frequencies common to both the first set and the second set.

36-37. (canceled)

38. The apparatus according to claim 33, wherein the query includes an indication of the location of the white space device.

39. The apparatus according to claim 38, wherein the indication of the location of the white space device included in the query comprises one or more of geo-location data identifying the location of the white space device, positioning coordinates, an identification of a cell on which the white space device is camped, identification of a network access point on which the white space device is camped, or an internet protocol address for the white space device.

40. The apparatus according to claim 33, wherein the first database is maintained by a first national regulatory authority of a first country and the second database is maintained by a second national regulatory authority of a second country.

41. The apparatus according to claim 33, wherein the at least one memory and stored computer program code are configured, with the at least one processor, to further cause the apparatus to:
determine whether the location of the white space device is within an area served by the first database; and
in an instance in which it is determined that the location of the white space device is not within the area served by the first database:
determine a database serving an area including the location of the white space device; and
cause access information for the database serving the area including the location of the white space device to be provided to the white space device in lieu of the determined available frequency spectrum.

42-55. (canceled)

56. An apparatus comprising at least one processor and at least one memory storing computer program code, wherein the at least one memory and stored computer program code are configured, with the at least one processor, to cause the apparatus to at least:
cause a query of a first database for an indication of available frequency spectrum at a location of the apparatus to be sent to a database apparatus configured to provide access to the first database;
in an instance in which the location of the apparatus is within an area served by the first database, receiving an indication of available frequency spectrum at the location of the apparatus; and
in an instance in which the location of the apparatus is not within the area served by the first database, receiving access information for a second database, the second database serving an area including the location of the apparatus.

57. The apparatus according to claim 56, wherein the at least one memory and stored computer program code are configured, with the at least one processor, to further cause the apparatus to:
use the access information for the second database to query the second database for an indication of available frequency spectrum at the location of the apparatus.

58-59. (canceled)

60. The apparatus according to claim 56, wherein the query includes an indication of the location of the apparatus, thereby enabling the first database to determine whether the location of the apparatus is within the area served by the first database.

61. The apparatus according to claim 60, wherein the indication of the location of the apparatus comprises one or more of geo-location data identifying the location of the apparatus, positioning coordinates, an identification of a cell on which the apparatus is camped, identification of a network access point on which the apparatus is camped, or an internet protocol address for the apparatus.

62. The apparatus according to claim 56, wherein the first database is maintained by a first national regulatory authority of a first country and the second database is maintained by a second national regulatory authority of a second country.

63. (canceled)

64. The apparatus according to claim 56, wherein the at least one memory and stored computer program code are configured, with the at least one processor, to further cause the apparatus to:
in an instance in which the location of the apparatus is within the area served by the first database and a transmission interference zone of the apparatus extends into an area served by another database, receive an indication of available frequency spectrum having been determined based on both the first database and the another database.

65. The apparatus according to claim 56, wherein the apparatus comprises or is embodied on a white space device.

66. The apparatus according to claim 56, wherein the apparatus comprises or is embodied on a mobile phone, the mobile phone comprising user interface circuitry and user interface software stored on one or more of the at least one memory; wherein the user interface circuitry and user interface software are configured to:
facilitate user control of at least some functions of the mobile phone through use of a display; and
cause at least a portion of a user interface of the mobile phone to be displayed on the display to facilitate user control of at least some functions of the mobile phone.

67-88. (canceled)
